(19) United States
(12) Patent Application Publication
(10) Pub. No.: US 2015/0323338 A1
(43) Pub. Date: Nov. 12, 2015

(54) HISTORICAL NAVIGATION MOVEMENT INDICATION

(71) Applicant: Nokia Corporation, Espoo (FI)

(72) Inventor: Roope Rainisto, Helsinki (FI)

(21) Appl. No.: 14/274,453

(22) Filed: May 9, 2014

(51) Int. Cl. G01C 21/36

(52) U.S. Cl. CPC G01C 21/36

(57) ABSTRACT

A method comprising determining a user apparatus location of a user apparatus, determining historical navigation movement data based, at least in part, on the user apparatus location, the historical navigation movement data comprising at least one historical navigation route, and causing display of a historical navigation movement indication that indicates a direction from the user apparatus location, the direction being indicative of, at least a portion of, the historical navigation movement data is disclosed.

### TECHNICAL FIELD

The technical field relates generally to historical navigation movement data.

### BACKGROUND

Over the years, electronic apparatuses have become increasingly prevalent in our society. As a result, many users of electronic apparatuses have become increasingly reliant upon their electronic apparatuses for purposes relating to mapping, navigation, routing, etc. As such, it may be desirable to configure an electronic apparatus such that a user of the electronic apparatus may utilize the electronic apparatus for such purposes easily and intuitively.

### SUMMARY

One or more embodiments provide for an apparatus comprising at least one processor, at least one memory including computer program code, the memory and the computer program code configured to, working with the processor, cause the apparatus to perform determination of a user apparatus location of a user apparatus, determination of historical navigation movement data based, at least in part, on the user apparatus location, the historical navigation movement data comprising at least one historical navigation route, and causation of display of a historical navigation movement indication that indicates a direction from the user apparatus location, the direction being indicative of, at least a portion of, the historical navigation movement data.

One or more embodiments provide for a computer readable medium that, when executed by a processor, perform determination of a user apparatus location of a user apparatus, determination of historical navigation movement data based, at least in part, on the user apparatus location, the historical navigation movement data comprising at least one historical navigation route, and causation of display of a historical navigation movement indication that indicates a direction from the user apparatus location, the direction being indicative of, at least a portion of, the historical navigation movement data.

One or more embodiments provide for a computer program product that, when executed by a processor, perform determination of a user apparatus location of a user apparatus, determination of historical navigation movement data based, at least in part, on the user apparatus location, the historical navigation movement data comprising at least one historical navigation route, and causation of display of a historical navigation movement indication that indicates a direction from the user apparatus location, the direction being indicative of, at least a portion of, the historical navigation movement data.

One or more embodiments provide for a method for determining a user apparatus location of a user apparatus, determining historical navigation movement data based, at least in part, on the user apparatus location, the historical navigation movement data comprising at least one historical navigation route, and causing display of a historical navigation movement indication that indicates a direction from the user apparatus location, the direction being indicative of, at least a portion of, the historical navigation movement data.

One or more embodiments provide for an apparatus having means for determining a user apparatus location of a user apparatus, means for determining historical navigation movement data based, at least in part, on the user apparatus location, the historical navigation movement data comprising at least one historical navigation route, and means for causing display of a historical navigation movement indication that indicates a direction from the user apparatus location, the direction being indicative of, at least a portion of, the historical navigation movement data.

In at least one example embodiment, the apparatus is the user apparatus.

In at least one example embodiment, the historical navigation route is associated with an apparatus that is different from the user apparatus.

In at least one example embodiment, the historical navigation route is indicative of a route traveled by an apparatus that is different from the user apparatus.

In at least one example embodiment, the user apparatus is associated with a user identity, and the historical navigation movement data is independent of the user identity.

In at least one example embodiment, the determination of the historical navigation movement data comprises receipt of information indicative of the historical navigation movement data.

In at least one example embodiment, the historical navigation movement data is received from at least one of a memory or a separate apparatus.

In at least one example embodiment, the determination of the historical navigation movement data further comprises sending of a request for the historical navigation movement data to a separate apparatus, and the information indicative of the historical navigation movement data is received from the separate apparatus.

In at least one example embodiment, the direction is indicative of, at least a portion of, the historical navigation route.

In at least one example embodiment, the historical navigation movement data comprises at least one historical navigation attribute that is associated with the historical navigation route.

In at least one example embodiment, the historical navigation attribute indicates at least one circumstance of a route traveled by an apparatus that is different from the user apparatus, the route being indicated by the historical navigation route.

In at least one example embodiment, the circumstance comprises at least one of a user circumstance or a travel circumstance.

In at least one example embodiment, the user circumstance comprises information indicative of a relationship between a user and a geographical region associated with the route being indicated by the historical navigation route.

In at least one example embodiment, the relationship between the user and the geographic region is signified by at least one of a tourist historical navigation attribute or a non-tourist historical navigation attribute.

In at least one example embodiment, the travel circumstance comprises information indicative of at least one environmental condition in existence when the route being indicated by the historical navigation route was traveled.

In at least one example embodiment, the environmental condition is signified by at least one of a date, a time, a season, or a weather condition.

In at least one example embodiment, the historical navigation movement data comprises another historical navigation route, and further comprising causation of display of another historical navigation movement indication that indicates another direction from the user apparatus location, the other direction being indicative of, at least a portion of, the other historical navigation route.

In at least one example embodiment, the historical navigation movement data comprises at least one other historical navigation attribute that is associated with the other historical navigation route.

In at least one example embodiment, a historical navigation attribute that is associated with the historical navigation route fails to correspond with the other historical navigation attribute.

In at least one example embodiment, the determination of the historical navigation movement data comprises receipt of unfiltered historical navigation movement data, and determination of the historical navigation movement data to be a subset of the unfiltered navigation movement data based, at least in part, on at least one filtration criteria.

In at least one example embodiment, the filtration criteria indicates at least one of a value or a range of values associated with a historical navigation attribute.

In at least one example embodiment, the unfiltered historical navigation movement data is received from at least one of a memory or a separate apparatus.

One or more example embodiments further perform determination of the filtration criteria based, at least in part, on the receipt of the unfiltered historical navigation movement data

In at least one example embodiment, the determination of the historical navigation movement data comprises receipt of unfiltered historical navigation movement data, the unfiltered historical navigation movement data comprising the historical navigation route and at least one historical navigation attribute that is associated with the historical navigation route and another historical navigation route and at least one other historical navigation attribute that is associated with the other historical navigation route, and determination of the historical navigation movement data to include the historical navigation route based, at least in part, on at least one filtration criteria and the historical navigation attribute.

In at least one example embodiment, the determination of the historical navigation movement data to include the historical navigation route comprises determination that the historical navigation attribute satisfies the filtration criteria, and the determination of the historical navigation movement data to include the historical navigation route is based, at least in part, on the determination that the historical navigation attribute satisfies the filtration criteria.

In at least one example embodiment, the determination of the historical navigation movement data comprises determination of the historical navigation movement data to exclude the other historical navigation route based, at least in part, on the filtration criteria and the other historical navigation attribute.

In at least one example embodiment, the determination of the historical navigation movement data to exclude the other historical navigation route comprises determination that the other historical navigation attribute fails to satisfy the filtration criteria, and the determination of the historical navigation movement data to exclude the other historical navigation route is based, at least in part, on the determination that the other historical navigation attribute fails to satisfy the filtration criteria.

In at least one example embodiment, the determination of the historical navigation movement data comprises sending of at least one filtration criteria to a separate apparatus, and receipt of the historical navigation movement data from the separate apparatus such that the historical navigation movement data includes one or more historical navigation routes that satisfy the filtration criteria and excludes one or more historical navigation routes that fail to satisfy the filtration criteria.

One or more example embodiments further perform determination of the filtration criteria.

In at least one example embodiment, the determination of the filtration criteria comprises receipt of information indicative of a filtration criteria indication input that indicates the filtration criteria.

In at least one example embodiment, the determination of the filtration criteria comprises retrieval of information indicative of the filtration criteria from at least one memory.

In at least one example embodiment, the filtration criteria indicates at least one historical navigation attribute.

In at least one example embodiment, a particular historical navigation route satisfying the filtration criteria refers to a historical navigation attribute associated with the particular historical navigation route satisfying the filtration criteria.

In at least one example embodiment, the historical navigation movement data is independent of current navigation movement data.

In at least one example embodiment, the current navigation movement data is indicative of traffic data.

In at least one example embodiment, the determination of the user apparatus location of the user apparatus comprises receipt of information indicative of the user apparatus location.

In at least one example embodiment, the determination of the user apparatus location of the user apparatus comprises receipt of information indicative of the user apparatus location from at least one of a global positioning system, a cellular communication system, or a location service.

In at least one example embodiment, the determination of the historical navigation movement data comprises sending of information indicative of the user apparatus location to a separate apparatus, and receipt of the historical movement data from the separate apparatus based, at least in part, on the sending of information indicative of the user apparatus location to the separate apparatus.

One or more example embodiments further perform causation of display of a visual representation of at least a portion of a map, wherein the causation of display of the historical navigation movement indication comprises causation of display of the historical navigation movement indication in relation to the portion of the map.

One or more example embodiments further perform determination of the portion of the map based, at least in part, on the user apparatus location.

In at least one example embodiment, the determination of the portion of the map comprises sending of information indicative of the user apparatus location to a separate apparatus, and receipt of information indicative of the portion of the map from the separate apparatus.

One or more example embodiments further perform determination of the historical navigation movement indication based, at least in part, on the historical navigation movement data.

In at least one example embodiment, at least one historical navigation movement indication characteristic of the historical navigation movement indication is based, at least in part, on the historical navigation movement data.

In at least one example embodiment, the historical navigation movement indication characteristic is at least one of an opacity of the historical navigation movement indication, a translucency of the historical navigation movement indication, a dimension of the historical navigation movement indication, an animation of the historical navigation movement indication, a color of the historical navigation movement indication, or a style of the historical navigation movement indication.

In at least one example embodiment, the historical navigation movement data indicates a number of traversals of the historical navigation route by one or more apparatus that is different from the user apparatus, and the historical navigation movement indication characteristic of the historical navigation movement indication is based, at least in part, on the number of traversals of the historical navigation route.

In at least one example embodiment, the historical navigation movement indication is indicative of the number of traversals of the historical navigation route.

One or more example embodiments further perform sending of information indicative of the user apparatus location to a separate apparatus.

In at least one example embodiment, the determination of the user apparatus location comprises receipt of information indicative of the user apparatus location, the determination of the historical navigation movement data comprises retrieval of the historical navigation movement data from at least one memory, and the causation of display of the historical navigation movement indication comprises sending of information indicative of the historical navigation movement indication to a separate apparatus such that the separate apparatus is caused to display the historical navigation movement indication.

In at least one example embodiment, the determination of the user apparatus location comprises receipt of information indicative of the user apparatus location, the determination of the historical navigation movement data comprises receipt of the historical navigation movement data from a separate apparatus, and the causation of display of the historical navigation movement indication comprises display of the historical navigation movement indication on a display.

In at least one example embodiment, the causation of display of the historical navigation movement indication comprises display of the historical navigation movement indication on a see through display such that the historical navigation movement indication corresponds with one or more object viewable through the see through display.

In at least one example embodiment, the object is at least one of a sign, a building, a road, a street, a walkway, a sidewalk, a path, a trail, or a portion of ground.

Although various aspects of embodiments are set out in the claims, the summary, and the description, other aspects of the embodiments comprise other combinations of features from other described embodiments. In this manner, the embodiments include the combinations explicitly set out in the claims, the summary, and the description, as well as any other suitable combinations of any suitable features.

### BRIEF DESCRIPTION OF THE DRAWINGS

For a more complete understanding of embodiments of the invention, reference is now made to the following descriptions taken in connection with the accompanying drawings in which:

FIG. 1 is a block diagram showing an apparatus according to at least one example embodiment;

FIG. 2 is a block diagram showing apparatus communication according to at least one example embodiment;

FIGS. 3A-3B are diagrams illustrating see through displays according to at least one example embodiment;

FIGS. 4A-4F are diagrams illustrating a representation of a user apparatus location and/or at least one historical navigation movement indication in relation to a map according to at least one example embodiment.

FIG. 5 is a flow diagram illustrating activities associated with causation of display of a historical navigation movement indication according to at least one example embodiment;

FIG. 6 is a flow diagram illustrating activities associated with causation of display of a historical navigation movement indication according to at least one example embodiment;

FIG. 7 is a flow diagram illustrating activities associated with causation of display of a historical navigation movement indication according to at least one example embodiment; and

FIG. 8 is a flow diagram illustrating activities associated with causation of display of a historical navigation movement indication according to at least one example embodiment.

### DETAILED DESCRIPTION OF THE DRAWINGS

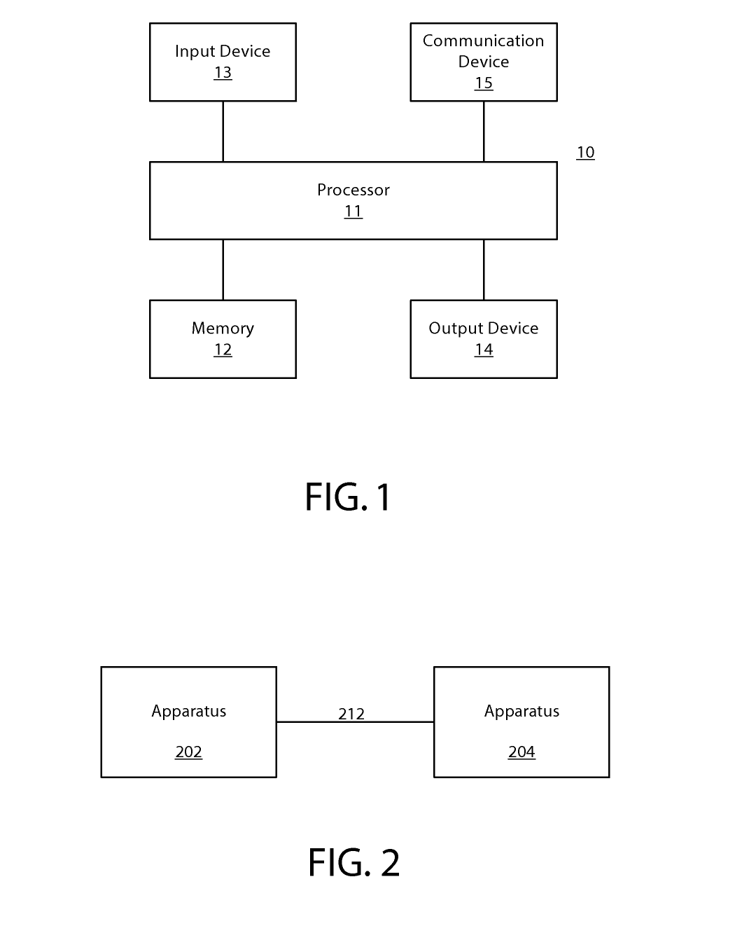

An embodiment of the invention and its potential advantages are understood by referring to FIGS. 1 through 8 of the drawings.

Some embodiments will now be described more fully hereinafter with reference to the accompanying drawings, in which some, but not all, embodiments are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

FIG. 1 is a block diagram showing an apparatus, such as an electronic apparatus 10, according to at least one example embodiment. It should be understood, however, that an electronic apparatus as illustrated and hereinafter described is merely illustrative of an electronic apparatus that could benefit from embodiments of the invention and, therefore, should not be taken to limit the scope of the invention. While electronic apparatus 10 is illustrated and will be hereinafter described for purposes of example, other types of electronic apparatuses may readily employ embodiments of the invention. Electronic apparatus 10 may be a personal digital assistant (PDAs), a pager, a mobile computer, a desktop computer, a television, a gaming apparatus, a laptop computer, a tablet computer, a media player, a camera, a video recorder, a mobile phone, a global positioning system (GPS) apparatus, a head mounted apparatus, a see through display, an automobile, a kiosk, an electronic table, and/or any other types of electronic systems. Moreover, the apparatus of at least one example embodiment need not be the entire electronic apparatus, but may be a component or group of components of the electronic apparatus in other example embodiments. For example, the apparatus may be an integrated circuit, a set of integrated circuits, and/or the like.

Furthermore, apparatuses may readily employ embodiments of the invention regardless of their intent to provide mobility. In this regard, even though embodiments of the invention may be described in conjunction with mobile applications, it should be understood that embodiments of the invention may be utilized in conjunction with a variety of other applications, both in the mobile communications industries and outside of the mobile communications industries. For example, the apparatus may be, at least part of, a non-carryable apparatus, such as a large screen television, an electronic table, a kiosk, an automobile, and/or the like.

In the example of FIG. 1, electronic apparatus 10 comprises processor 11 and memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

In the example of FIG. 1, electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

In the example of FIG. 1, processor 11 may comprise means, such as circuitry, for implementing audio, video, communication, navigation, logic functions, and/or the like, as well as for implementing embodiments of the invention including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 1 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

In the example of FIG. 1, electronic apparatus 10 may comprise a user interface for providing output and/or receiving input. The electronic apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output device 14 may comprise a visual output device, such as a display, a light, and/or the like. In at least one example embodiment, the apparatus causes display of information, the causation of display may comprise displaying the information on a display comprised by the apparatus, sending the information to a separate apparatus that comprises a display, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like. In at least one example embodiment, the apparatus receives an indication of an input. The apparatus may receive the indication from a sensor, a driver, a separate apparatus, and/or the like. The information indicative of the input may comprise information that conveys information indicative of the input, indicative of an aspect of the input indicative of occurrence of the input, and/or the like.

In the example of FIG. 1, electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. In addition, or alternatively, the electronic apparatus 10 may comprise an interface device such as a joystick or other user input interface.

In the example of FIG. 1, input device 13 may comprise a media capturing element. The media capturing element may be any means for capturing an image, video, and/or audio for storage, display or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format.

FIG. 2 is a block diagram showing apparatus communication according to at least one example embodiment. The example of FIG. 2 is merely an example and does not limit the scope of the claims. For example, apparatus count may vary, apparatus configuration may vary, communication channels may vary, and/or the like.

In the example of FIG. 2, apparatus 202 communicates with apparatus 204 by way of communication channel 212. In the example of FIG. 2, apparatus 202 may be a user apparatus. A user apparatus may be a phone, a tablet, a handheld apparatus, a laptop, a head mounted display, and/or the like. In the example of FIG. 2, apparatus 204 may be a For example, apparatus 202 may send information to apparatus 204 by way of communication channel 212, apparatus 202 may receive information sent from apparatus 204 by way of communication channel 212, and/or the like. It should be understood that, even though the example of FIG. 2 illustrates a direct communication channel between apparatus 202 and apparatus 204, there may be intermediate apparatuses that facilitate communication between apparatus 202 and apparatus 204. For example, there may be one or more routers, hubs, switches, gateways, and/or the like, that are utilized in the communication channels between apparatus 202 and apparatus 204. In addition, there may be other separate apparatuses that apparatus 202 and/or apparatus 204 are in communication with. For example, apparatus 202 and/or apparatus 204 may be in communication with another apparatus, a separate apparatus, a different apparatus, a server apparatus, and/or the like.

In at least one example embodiment, an apparatus and a separate apparatus communicate by way of one or more communication channels. For example, as depicted in FIG. 2, apparatus 202 communicates with apparatus 204 by way of communication channel 212. In the example of FIG. 2, communication channel 212 may be a local area network communication channel, a wide area network communication channel, an internet communication channel, a cellular communication channel, and/or the like.

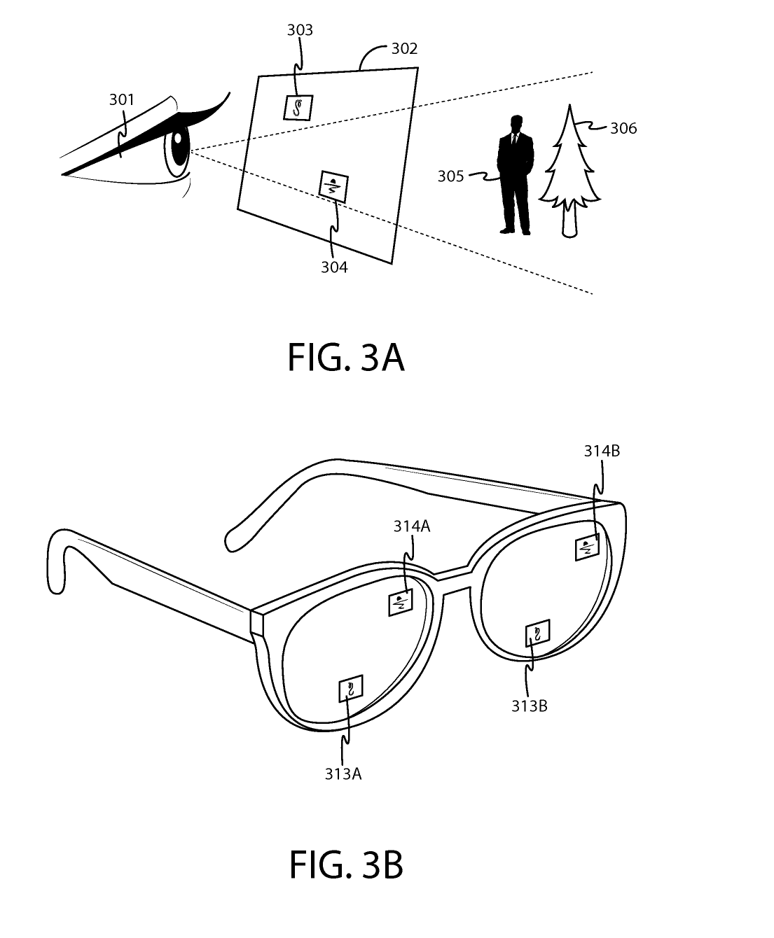

FIGS. 3A-3B are diagrams illustrating see through displays according to at least one example embodiment. The examples of FIGS. 3A-3B are merely examples and do not limit the scope of the claims. For example, configuration of the see through display may vary, relationship between the user and the see through display may vary, shape of the see through display may vary, opacity of the see through display may vary, and/or the like.

In modern times, electronic apparatuses are becoming more prevalent and pervasive. Users often utilize such apparatuses for a variety of purposes. For example, a user may utilize an apparatus to view information that is displayed on a display of the apparatus, to perceive information associated with the user's surroundings on the display of the apparatus, and/or the like. In many circumstances, a user may desire to view information associated with an apparatus in a way that is noninvasive, nonintrusive, discreet, and/or the like. In such circumstances, it may be desirable for a display to be a see through display. In at least one example embodiment, a see through display is a display that presents information to a user, but through which objects on an opposite side of the display from the user may be seen. A see through display may be comprised by a window, a windshield, a visor, glasses, a head mounted display, and/or the like. In at least one example embodiment, an apparatus is a head mounted display. A head mounted display may, for example, be a display that is head mountable, a display that is coupled to an element that wearable at a location on and/or proximate to the head of a user, a display that is wearable at a location on and/or proximate to the head of a user, and/or the like.

In some circumstances, it may be desirable for a display to preclude a user from seeing objects that may be positioned beyond the display. For example, a user may prefer to have information displayed on a solid display, have information displayed against a solid background, to avoid distractions that may be associated with perception of information on a see through display, and/or the like. In at least one example embodiment, a head mounted display may comprise an opaque display. An opaque display may be a display that is not a see through display, a display through which objects on an opposite side of the display may be obscured, and/or the like.

FIG. 3A is a diagram illustrating see through display 302 according to at least one example embodiment. In at least one example embodiment, displaying information on a see through display so that the information corresponds with one or more objects viewable through the see through display is referred to as augmented reality. In the example of FIG. 3A, user 301 may perceive objects 305 and 306 through see through display 302. In at least one example embodiment, the see through display may display information to the user. For example, display 302 may display information 303 and information 304. Information 303 and information 304 may be positioned on display 302 such that the information corresponds with one or more objects viewable through see through display 302, such as object 305. In such an example, information 303 may be associated with, identify, and/or the like, object 305. For example, information 303 may indicate an identity of object 305. In at least one example embodiment, display 302 may be comprised by a head mounted display.

FIG. 3B is a diagram illustrating a see through display according to at least one example embodiment. In at least one example embodiment, a see through display is a near eye display. A near eye display may be a see through display that is positioned proximate to an eye of the user. The example of FIG. 3B illustrates glasses that comprise a near eye display in each lens. In the example of FIG. 3B, the right near eye display is displaying information 313A and 314A, and the left near eye display is displaying information 313B and 314B. In at least one example embodiment, information 313A may be associated with information 313B. For example, the content of information 313A may be identical to content of information 313B. In some circumstances, even though the content may be identical between 313A and 313B, position of information 313A on the right near eye display may vary from position of information 313B on the left near eye display. In this manner, the apparatus may vary position of information between the left near eye display and right near eye display to vary the parallax of the information perceived by the user. In this manner, the apparatus may vary the perceived depth of the information by the user.

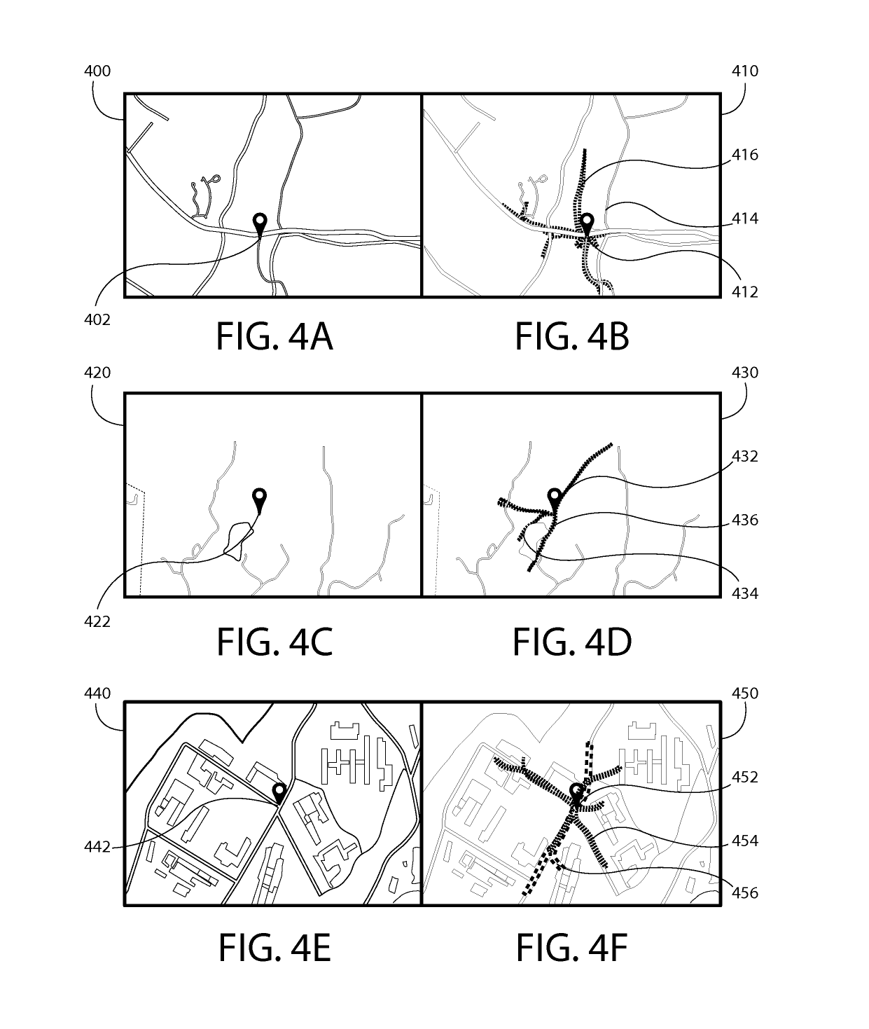

FIGS. 4A-4F are diagrams illustrating a representation of a user apparatus location and/or at least one historical navigation movement indication in relation to a map according to at least one example embodiment. The examples of FIGS. 4A-4F are merely examples and do not limit the scope of the claims. For example, map configuration may vary, visual content may vary, user apparatus location may vary, historical navigation movement indication may vary, and/or the like.

In many circumstances, a user may enjoy visiting a new location, sightseeing various landmarks, eating at a local diner, and/or the like. In such circumstances, the user may desire to utilize the user's electronic apparatus to assist the user in determining a route to a location, navigating from a location to a different location, selecting a location to visit, identifying popular locations and/or routes, and/or the like. For example, the user may utilize a navigation-related application operating on the user's electronic apparatus in order to explore and understand the user's location, to find new locations and/or new destinations, and/or the like.

In order to facilitate such user activities, it may be desirable to determine a location of a user, a location of the user's electronic apparatus, and/or the like. For example, the user may desire to identify locations that are near the user, proximate to the user, within walking distance from the user, within driving distance from the user, and/or the like. In this manner, it may be desirable to determine a location of the user by way of the location of the user's electronic apparatus such that the user may perceive information that is relevant to the user's location. In at least one example embodiment, an apparatus determines a user apparatus location of a user apparatus. The user apparatus may be an electronic apparatus, such as a phone, a tablet, a handheld apparatus, a laptop, a head mounted display, and/or the like. In such an example embodiment, the user apparatus location may be the geographical location of the user apparatus. In at least one example embodiment, the determination of the user apparatus location comprises receipt of information indicative of the user apparatus location. For example, the determination of the user apparatus location may comprise receipt of information indicative of the user apparatus location from a global positioning system, a cellular communication system, a location service, and/or the like. In at least one example embodiment, the apparatus is the user apparatus. In such an example embodiment, the apparatus may determine a location of the apparatus. For example, the apparatus may receive information indicative of the location of the apparatus from a global positioning system, a cellular communication system, a location service, and/or the like

In many circumstances, a map may indicate a location of specific destinations, such as places, buildings, natural landmarks, and/or the like. In such circumstances, a user may look at the map by way of the user's electronic apparatus in order to find a specific destination, to search through destinations by name, to browse through various categories of locations, and/or the like. As such, the map may allow a user to determine where the user is currently located, and what places are near the user. In some circumstances, a user may desire to explore a particular geographic region, such as a downtown metropolitan area, a nature preserve, and/or the like. In such circumstances, the user may desire to know where other individuals have gone in the past, routes that locals commonly travel, routes that tourists commonly travel, and/or the like. For example, the locals, or individuals that have lived in a certain city for a long time or frequently travel to the certain city, may gain intimate knowledge regarding the popularity of particular restaurants, diners, bars, and/or the like. Similarly, the locals may know which routes are interesting, which routes to avoid, and/or the like. In another example, tourists may commonly follow particular routes that travel near landmarks, interesting locations, scenic views, and/or the like. In this manner, it may be desirable to provide a user with information that facilitates the user in deciding where to go from a particular location.

Such information may be based, at least in part, on data collected from other individuals that are navigating from the same location as the user of the electronic apparatus. In at least one example embodiment, an apparatus determines historical navigation movement data. In such an example embodiment, the historical navigation movement data may be based, at least in part, on the user apparatus location. In at least one example embodiment, historical navigation movement data is data that is indicative of prior navigation within a particular geographic region, navigation from a particular location, and/or the like. In at least one example embodiment, the historical navigation movement data may comprise one or more historical navigation route. In such an example embodiment, the historical navigation route may be associated with an apparatus that is different from the user apparatus. For example, the historical navigation route may be indicative of a route traveled by an apparatus that is different from the user apparatus. In such an example, prior to the user apparatus being at the user apparatus location, another individual may have been located at a location proximate to the user apparatus location. In such an example, the other individual may have departed the location and followed a specific route from the location. In such an example, the historical navigation route may be indicative of the specific route traveled by the other individual, the other individual's apparatus, and/or the like.

As discussed previously, in many circumstances, a user may desire to utilize historical navigation movement data in order to facilitate navigation through a particular geographic region, from a specific user apparatus location, and/or the like. In some circumstances, a user may desire to reference historical navigation movement data associated with locals. In such circumstances, the user may desire to discover locations and/or routes that other individuals with enhanced knowledge of the user's surrounds commonly visit and/or follow. In other circumstances, the user may desire to reference historical navigation movement data associated with tourists. In such circumstances, the user may be a tourist to the area, and may desire to discover locations and/or routes that tourists with limited knowledge of the user's surroundings, or with knowledge of tourist-oriented destinations and interests, commonly visit and/or follow. In some circumstances, other individuals may commonly follow a specific route, and in different circumstances, the individuals may follow a different route. For example, the individuals may visit varying locations and/or follow varying routes based, at least in part, on a day of the week, a time of day, a month, a season, and/or the like. In such an example, an individual that is a local may commonly travel to work on a weekday mornings, and travel to entertainment-related destinations on weekday evenings and/or weekend days, and/or the like.

As such, it may be desirable to permit a user to distinguish between historical navigation movement data associated with locals, tourists, summer, winter, day, night, and/or the like. In order to facilitate such distinguishment, it may be desirable characterize the historical navigation movement data, the historical navigation routes, the other individuals associated with the historical navigation movement data, and/or the like. In at least one example embodiment, the historical navigation movement data comprises at least one historical navigation attribute that is associated with the historical navigation route. For example, the historical navigation attribute may indicate one or more circumstance of a route traveled by an apparatus that is different from the user apparatus. In such an example, the route may be indicated by the historical navigation route, may correspond with the historical navigation route, and/or the like.

The circumstance may be a user circumstance, a travel circumstance, and/or the like. For example, a user circumstance may comprise information indicative of a relationship between a user and a geographical region associated with the route being indicated by the historical navigation route. In such an example, the relationship between the user and the geographic region may be signified by a tourist historical navigation attribute, a non-tourist historical navigation attribute, and/or the like. As discussed previously, a tourist may be an individual who is temporarily visiting a particular region, an individual who is unfamiliar with a particular area, an individual who is on vacation, and/or the like. A non-tourist, on the other hand, may be in individual who is familiar with a particular area, who lives proximate to a specific location, who works near the user apparatus location, and/or the like. In this manner, as discussed previously, tourists may commonly travel routes that are different than the routes commonly traveled by non-tourists, may commonly visit locations that are different than the locations commonly visited by non-tourists, and/or the like. As such, it may be desirable to distinguish between such user circumstances.

In another example, a travel circumstance may comprise information indicative one or more environmental condition that may be in existence when the route being indicated by the historical navigation route was traveled. For example, the environmental condition may signify a date, a time, a season, a weather condition, and/or the like. In this manner, a user of a user apparatus may distinguish between travel circumstances associated with the traveling of a particular historical navigation route.

In at least one example embodiment, the determination of the historical navigation movement data comprises receipt of information indicative of the historical navigation movement data. In such an example embodiment, the historical navigation movement data may be received from memory, a separate apparatus, and/or the like. For example, the apparatus may retrieve information indicative of the historical navigation movement data from at least one memory. In another example, the apparatus may receive information indicative of the historical navigation movement data from a separate apparatus, such as a server, a location service, and/or the like. In such an example, the apparatus may send a request for the historical navigation movement data to the separate apparatus such that the apparatus receives the information indicative of the historical navigation movement data from the separate apparatus. In order to facilitate determination of and/or receipt of historical navigation movement data that is relevant and/or useful to the user, it may be desirable to determine the historical navigation movement data based, at least in part, on the user apparatus location of the user apparatus. In this manner, the apparatus may send information indicative of a user apparatus location to a separate apparatus, and receive historical movement data from the separate apparatus. In such an example, the receipt of the historical movement data from the separate apparatus may be based, at least in part, on the sending of information indicative of the user apparatus location to the separate apparatus.

In some circumstances, a user may desire that the historical navigation movement data comprise data that is particularly useful to the user, relevant to a particular user circumstances, applicable to a given travel circumstance, and/or the like. For example, the user may visit a particular location as a tourist during the summer. In such an example, the user may desire that the historical navigation movement data comprises data that reflects the tourist historical navigation attribute, the summer-oriented travel circumstance, and/or the like. As such, it may be desirable to configure an apparatus such that a user of the apparatus may selectively perceive historical navigation movement data that is associated with certain user circumstances, travel circumstances, historical navigation attributes, and/or the like.

In some circumstances, an apparatus may receive unfiltered historical navigation movement data. Unfiltered historical navigation movement data may be data prior to filtration, inclusive of historical navigation routes associated with all user circumstances and/or travel circumstances, and/or the like. In at least one example embodiment, determination of the historical navigation movement data comprises receipt of unfiltered historical navigation movement data, and determination of the historical navigation movement data to be a subset of the unfiltered navigation movement data. In such an example embodiment, the determination of the historical navigation movement data to be a subset of the unfiltered navigation movement data may be based, at least in part, on one or more filtration criteria. In at least one example embodiment, filtration criteria indicates at least one historical navigation attribute. For example, the filtration criteria may indicate a value, a range of values, and/or the like, associated with a historical navigation attribute. For example, the filtration criteria may cause exclusion of historical navigation routes traversed during winter, inclusion of historical navigation routes traversed in the evening, exclusion of historical navigation routes traversed by tourists, and/or the like. The unfiltered historical navigation movement data may be received from memory, a separate apparatus, and/or the like. The filtration criteria may be user configurable, predefined, and/or the like. In at least one example embodiment, an apparatus determines one or more filtration criteria. For example, determination of the filtration criteria may comprise receipt of information indicative of a filtration criteria indication input that indicates the filtration criteria, retrieval of information indicative of the filtration criteria from at least one memory, receipt of information indicative of the filtration criteria from a separate apparatus, and/or the like. In at least one example embodiment, determination of the filtration criteria is based, at least in part, on the receipt of the unfiltered historical navigation movement data. For example, the apparatus may receive unfiltered historical navigation movement data and, subsequently, determine one or more filtration criteria based, at least in part, on the receipt of the unfiltered historical navigation movement data.

For example, the apparatus may receive unfiltered historical navigation movement data that may comprise a historical navigation route and at least one historical navigation attribute that is associated with the historical navigation route, and another historical navigation route and at least one other historical navigation attribute that is associated with the other historical navigation route. For example, the historical navigation attribute may indicate that the historical navigation route was traversed by a tourist, and the other historical navigation attribute may indicate that the other historical navigation route was traversed by a non-tourist. In such an example, a user may desire to filter out historical navigation routes that were traversed by non-tourists. For example, the user may be a tourist, the user may desire to navigate to tourist-oriented landmarks, and/or the like. In such an example, the apparatus may determine the historical navigation movement data to include the historical navigation route based, at least in part, on one or more filtration criteria, the historical navigation attribute, and/or the like. In at least one example embodiment, the determination of the historical navigation movement data to include the historical navigation route comprises determination that the historical navigation attribute satisfies the filtration criteria. In such an example embodiment, the determination of the historical navigation movement data to include the historical navigation route may be based, at least in part, on the determination that the historical navigation attribute satisfies the filtration criteria. For example, the filtration criteria may indicate inclusion of historical navigation routes that are associated with a tourist historical navigation attribute. As such, the historical navigation attribute associated with the historical navigation route satisfies the filtration criteria.

In such an example, the apparatus may determine the historical navigation movement data to exclude the other historical navigation route based, at least in part, on the filtration criteria and the other historical navigation attribute. In at least one example embodiment, the determination of the historical navigation movement data to exclude the other historical navigation route comprises determination that the other historical navigation attribute fails to satisfy the filtration criteria. In such an example embodiment, the determination of the historical navigation movement data to exclude the other historical navigation route may be based, at least in part, on the determination that the other historical navigation attribute fails to satisfy the filtration criteria. For example, as discussed previously, the filtration criteria may indicate inclusion of historical navigation routes that are associated with a tourist historical navigation attribute. As such, since the other historical navigation attributed indicates that the other historical navigation route was traversed by a non-tourist, the other historical navigation attribute associated with the other historical navigation route may fail to satisfy the filtration criteria.

In some circumstances, it may be desirable to receive historical navigation movement data that has been filtered prior to receipt of the historical navigation movement data. For example, it may be desirable to reduce an amount of data received by the apparatus in order to conserve apparatus resources, reduce bandwidth utilization, and/or the like. In at least one example embodiment, the determination of the historical navigation movement data comprises sending of at least one filtration criteria to a separate apparatus, and receipt of the historical navigation movement data from the separate apparatus. In such an example embodiment, the historical navigation movement data received from the separate apparatus may include one or more historical navigation routes that satisfy the filtration criteria, excludes one or more historical navigation routes that fail to satisfy the filtration criteria, and/or the like. In at least one example embodiment, a particular historical navigation route satisfying the filtration criteria refers to a historical navigation attribute associated with the particular historical navigation route satisfying the filtration criteria.

In some circumstances, it may be desirable to avoid basing the determination of historical navigation movement data on certain information. For example, a user may desire to utilize historical navigation movement data that is independent of an identity of the user, an identity of the user apparatus, an identity of one or more individuals whom traversed historical navigation routes comprised by the historical navigation movement data, independent of current traffic conditions, and/or the like. In this manner, the user may desire to utilize historical navigation movement data that is primarily based on user circumstances, travel circumstances, and/or the like. In at least one example embodiment, a user apparatus is associated with a user identity. In such an example embodiment, the historical navigation movement data may be independent of the user identity. For example, a user apparatus that is located at a user apparatus location may determine historical navigation movement data that corresponds with historical navigation movement data determined by a different user apparatus at the same user apparatus location. In at least one example embodiment, the historical navigation movement data is independent of current navigation movement data. For example, the current navigation movement data may be indicative of traffic data. In such an example, the traffic data may be associated with travel times, road congestion, average travel speeds, road utilization, and/or the like. In such an example, the traffic data may be indicative of current conditions associated with a particular route, a specific historical navigation route, a set of historical navigation movement data, and/or the like.

In some circumstances, it may be desirable to identify one or more user circumstance and/or travel circumstance associated with the user apparatus. For example, the user apparatus may utilize a local service that provides historical navigation movement data to the user apparatus based, at least in part, on a user apparatus location of the user apparatus. In order to facilitate operation of such a location service, it may be desirable to contribute navigation-oriented data to the location service. In at least one example embodiment, an apparatus sends information indicative of a user apparatus location to a separate apparatus. The separate apparatus may be a server, a location service, and/or the like. In such an example embodiment, the apparatus may identify one or more characteristic associated with the user apparatus, such as a user circumstance, a travel circumstances, and/or the like, and send information indicative of the characteristic to the separate apparatus. In another example, the apparatus may send information indicative of the user apparatus location to the separate apparatus such that the separate apparatus may be able to identify one or more characteristic associated with the user apparatus, the user of the user apparatus, and/or the like. For example, a user of a user apparatus may utilize the user apparatus while traversing a particular route. The apparatus may identify a date of traversal, a time of traversal, whether the user is a tourist or a non-tourist, and/or the like. Similarly, the apparatus may send information indicative of the user apparatus location to a separate apparatus such that the separate apparatus may identify a date of traversal, a time of traversal, whether the user is a tourist or a non-tourist, and/or the like. In this manner, a repository of historical navigation movement data may be accumulated over time with the assistance of a plurality of users, user apparatuses, and/or the like.

In many circumstances, a user may desire to utilize the historical navigation movement data while walking around a city, sightseeing, hiking, and/or the like. In such circumstances, it may be desirable allow the user to utilize the historical navigation movement data in a manner that is easy and intuitive. For example, in order to facilitate utilization of the historical navigation movement data by the user, it may be desirable to cause display of visual information that is indicative of at least a portion of the historical navigation movement data. In at least one example embodiment, an apparatus causes display of a historical navigation movement indication. The historical navigation movement indication may indicate a direction from the user apparatus location. The direction may be indicative of, at least a portion of, historical navigation movement data, a historical navigation route, and/or the like.

In many circumstances, historical navigation movement data may comprise historical navigation routes that proceed in various directions from the user apparatus location. For example, at some time prior to the user arriving at the user apparatus location, other individuals may have traversed numerous routes that intersect with the user apparatus location, that pass near to the user apparatus location, and/or the like. For example, the historical navigation movement data may comprise a historical navigation route, and another historical navigation route. In such an example, the apparatus may cause display of a historical navigation movement indication that indicates a direction from the user apparatus location, another historical navigation movement indication that indicates another direction from the user apparatus location, and or the like. In such an example, the direction may be indicative of, at least a portion of, the historical navigation route, and the other direction may be indicative of, at least a portion of, the other historical navigation route. In this manner, a user may perceive visual information indicative of the historical navigation movement data, the historical navigation route, the other historical navigation route, and/or the like. In such an example, the historical navigation route may be associated with a tourist historical navigation attribute, and the other historical navigation route may be associated with a non-tourist historical navigation attribute. In such an example, the user may desire perceive historical navigation routes that were traversed by tourists, and may desire to avoid perceiving historical navigation routes that were traversed by non-tourists. As such, the user may indicate such a desire by way of one or more filtration criteria indication inputs that indicates inclusion of historical navigation routes associated with a tourist historical navigation attribute, exclusion of historical navigation routes associated with a non-tourist historical navigation attribute, and/or the like. In such an example, the apparatus may cause termination of display of the other historical navigation movement indication based, at least in part, on the filtration criteria.

In many circumstances, a user may desire to be able to quickly and easily differentiate between different types of historical navigation routes, between historical navigation routes that were traversed during the day and that were traversed during the evening, between historical navigation routes that are associated with a tourist historical navigation attribute and a non-tourist historical navigation attribute, and/or the like. As such, it may be desirable to configure an apparatus such that a user may identify one or more such attributes by way of an associated historical navigation movement indication. In at least one example embodiment, an apparatus determines the historical navigation movement indication. In such an example embodiment, the historical navigation movement indication may be based, at least in part, on the historical navigation movement data. For example, at least one historical navigation movement indication characteristic of the historical navigation movement indication may be based, at least in part, on the historical navigation movement data. In such an example, the historical navigation movement indication characteristic may be an opacity of the historical navigation movement indication, a translucency of the historical navigation movement indication, a dimension of the historical navigation movement indication, an animation of the historical navigation movement indication, a color of the historical navigation movement indication, a style of the historical navigation movement indication, and/or the like.

In at least one example embodiment, the historical navigation movement data indicates a number of traversals of the historical navigation route by one or more apparatus that is different from the user apparatus. In such an example embodiment, the historical navigation movement indication characteristic of the historical navigation movement indication may be based, at least in part, on the number of traversals of the historical navigation route. For example, the historical navigation movement indication may be indicative of the number of traversals of the historical navigation route. For example, a thinner historical navigation movement indication may indicate a lower number of traversals of a historical navigation route, and a thicker historical navigation movement indication may indicate a higher number of traversals of a historical navigation route. In another example, a less opaque historical navigation movement indication may indicate a lower number of traversals of a historical navigation route, and a more opaque historical navigation movement indication may indicate a higher number of traversals of a historical navigation route.

In order to provide a user with context, it may be desirable to cause display of the historical navigation movement indication in relation to a map. In many circumstances, the user may be familiar with utilization of a map, following of routing instructions, and/or the like. In such circumstances, a user may desire to perceive the historical navigation movement indication in relation to a map. In at least one example embodiment, an apparatus causes display of a visual representation of at least a portion of a map. In such an example embodiment, the causation of display of the historical navigation movement indication may comprise causation of display of the historical navigation movement indication in relation to the portion of the map. In such circumstances, it may be desirable for the portion of the map to correspond with the user apparatus location, to represent the geographical region surrounding the user apparatus location, and/or the like. In at least one example embodiment, the apparatus determines the portion of the map based, at least in part, on the user apparatus location. Determination of the portion of the map may comprise retrieval of information indicative of the portion of the map from memory, receipt of information indicative of the portion of the map from a separate apparatus, and/or the like. For example, the determination of the portion of the map may comprise sending of information indicative of the user apparatus location to a separate apparatus, and receipt of information indicative of the portion of the map from the separate apparatus.

FIG. 4A is a diagram illustrating a representation of a user apparatus location in relation to a map according to at least one example embodiment. The example of FIG. 4A illustrates at least a portion of map 400. In the example of FIG. 4A, map 400 depicts a geographic region associated with a small town. As can be seen, map 400 comprises representations of various highways, roads, streets, and/or the like. In the example of FIG. 4A, representation 402 indicates a user apparatus location of a user apparatus. For example, the user apparatus may comprise a display, and map 400 may be displayed by way of the display such that a user of the user apparatus may perceive map 400, representation 402 in relation to map 400, and/or the like.

FIG. 4B is a diagram illustrating at least one historical navigation movement indication in relation to a map according to at least one example embodiment. As can be seen, map 410 and representation 412 of FIG. 4B correspond with map 400 and representation 402 of FIG. 4A. In this manner, the example of FIG. 4B corresponds with the example of FIG. 4A, subsequent to display of historical navigation movement indication 416. In the example of FIG. 4B, historical navigation movement indication 416 is displayed in relation to map 410. In the example of FIG. 4B, historical navigation movement indication 416 indicates a historical navigation route that extends approximately north from the user apparatus location, indicated by representation 412. As can be seen in the example of FIG. 4B, several historical navigation movement indications are displayed in relation to map 410. For example, a historical navigation movement indication extends to the west from the user apparatus location, following the street depicted on map 410. In another example, another historical navigation movement indications extends to the south of the user apparatus location, closely following the small road depicted on map 410. In this manner, the two historical navigation movement indications may indicate that other individuals often navigate along the street to the west and along the small road to the south.

In the example of FIG. 4B, historical navigation movement indication 416 fails to correspond with an improved surface, such as with road 414. In this manner, historical navigation movement indication 416 indicates that, subsequent to the user and the user apparatus arriving at the user apparatus location, at least one other individual carrying a different user apparatus traversed the route indicated by historical navigation movement indication 416. Historical navigation movement indication 416 may indicate a route associated with a hiking trail, a running path, a shortcut frequently utilized by non-tourists, and/or the like. In the example of FIG. 4B, the road to the east of the user apparatus location fails to corresponds with a historical navigation movement indication. As such, map 410 may indicate that the user of the user apparatus should avoid traveling east from the user apparatus location, since few individuals travel to the east.

FIG. 4C is a diagram illustrating a representation of a user apparatus location in relation to a map according to at least one example embodiment. The example of FIG. 4C illustrates at least a portion of map 420. In the example of FIG. 4C, map 420 depicts a geographic region associated with a nature reserve. As can be seen, map 420 comprises representations of a lake, various small roads, and/or the like. In the example of FIG. 4C, representation 422 indicates a user apparatus location of a user apparatus. For example, the user apparatus may comprise a display, and map 420 may be displayed by way of the display such that a user of the user apparatus may perceive map 420, representation 422 in relation to map 420, and/or the like.

FIG. 4D is a diagram illustrating at least one historical navigation movement indication in relation to a map according to at least one example embodiment. As can be seen, map 430 and representation 432 of FIG. 4D correspond with map 420 and representation 422 of FIG. 4C. In this manner, the example of FIG. 4D corresponds with the example of FIG. 4C, subsequent to display of historical navigation movement indication 434 and historical navigation movement indication 436. In the example of FIG. 4D, historical navigation movement indication 434 and historical navigation movement indication 436 are displayed in relation to map 430. In the example of FIG. 4D, historical navigation movement indication 434 indicates a historical navigation route that extends approximately southwest from the user apparatus location, and historical navigation movement indication 436 indicates a historical navigation route that extends approximately south southwest from the user apparatus location. As can be seen, historical navigation movement indication 434 and historical navigation movement indication 436 flank the west and east sides of the lake, and fail to connect along the southern portion of the lake. In this manner, a user may infer that other individuals often travel along the western and eastern shorts of the lake, but avoid circumnavigating the shoreline.

As can be seen in the example of FIG. 4D, several historical navigation movement indications are displayed in relation to map 430. For example, a historical navigation movement indication extends to the west from the user apparatus location, intersection with the small road depicted on map 430. In this manner, the historical navigation movement indication that extends to the west from the user apparatus location may be associated with ingress and egress from the nature reserve, a hiking trail that extends toward a trailhead at the intersection with the small road, and/or the like. In another example, another historical navigation movement indications extends to the north northeast of the user apparatus location. As can be seen in the example of FIG. 4D, many of the historical navigation movement indications, including historical navigation movement indication 434 and historical navigation movement indication 436, fail to correspond with a highway, a street, a road, and/or the like. In this manner, the historical navigation movement indication may indicate routes associated with a hiking trail, a running path, a scenic trail, and/or the like. In the example of FIG. 4D, the region to the east of the user apparatus location fails to corresponds with a historical navigation movement indication. As such, map 430 may indicate that the user of the user apparatus should avoid traveling to the east from the user apparatus location, since few individuals travel to the east. Such an absence of historical navigation movement indications may indicate an unnavigable geographic region, a geographic region that lacks aesthetic appeal and/or entertainment value, and/or the like. As such, although map 420 of FIG. 4C fails to provide a user with substantive information regarding navigation within the geographic region depicted by map 420, a user may perceive historical navigation routes that depict commonly utilized trails, paths, and/or the like.

FIG. 4E is a diagram illustrating a representation of a user apparatus location in relation to a map according to at least one example embodiment. The example of FIG. 4E illustrates at least a portion of map 440. In the example of FIG. 4E, map 440 depicts a geographic region associated with a university. As can be seen, map 440 comprises representations of a several streets, various buildings, and/or the like. In the example of FIG. 4E, representation 442 indicates a user apparatus location of a user apparatus. For example, the user apparatus may comprise a display, and map 440 may be displayed by way of the display such that a user of the user apparatus may perceive map 440, representation 442 in relation to map 440, and/or the like.

FIG. 4F is a diagram illustrating at least one historical navigation movement indication in relation to a map according to at least one example embodiment. As can be seen, map 450 and representation 452 of FIG. 4F correspond with map 440 and representation 442 of FIG. 4E. In this manner, the example of FIG. 4F corresponds with the example of FIG. 4E, subsequent to display of historical navigation movement indication 454 and historical navigation movement indication 456. In the example of FIG. 4F, historical navigation movement indication 454 and historical navigation movement indication 456 are displayed in relation to map 450. In the example of FIG. 4F, historical navigation movement indication 454 indicates a historical navigation route that extends approximately southwest from the user apparatus location, and historical navigation movement indication 456 indicates a historical navigation route that extends approximately southeast from the user apparatus location.

As can be seen, historical navigation movement indication 454 indicates a route that passes near several large buildings. In the example of FIG. 4F, historical navigation movement indication 454 may be associated with a non-tourist historical navigation attribute. As such, historical navigation movement indication 454 may indicate a route commonly traversed by non-tourists, locals, and/or the like, such as by students of the university depicted on map 450. As can be seen, historical navigation movement indication 454 is indicated by a wide dashed line. In this manner, historical navigation movement indications associated with a wide dashed line may indicate routes that are associated with a non-tourist historical navigation attribute. If a user happens to desire to visit locations frequented by students of the university, to eat at a restaurant enjoyed by the locals, and/or the like, the user may desire to travel to the southeast to the buildings along the historical navigation route indicated by historical navigation movement indication 454.

As can be seen, historical navigation movement indication 456 terminates at a building to the south of the user apparatus location. In the example of FIG. 4F, historical navigation movement indication 456 may be associated with a tourist historical navigation attribute. As such, historical navigation movement indication 456 may indicate a route commonly traversed by tourists, visitors, and/or the like. As can be seen, historical navigation movement indication 456 is indicated by a dotted line. In this manner, historical navigation movement indications associated with a dotted line may indicate routes that are associated with a tourist historical navigation attribute. If a user happens to desire to navigate to a tourist attractive, towards entertainment venues, and/or the like, the user may desire to travel to the southwest to the building at the end of the historical navigation route indicated by historical navigation movement indication 456.

In some circumstances, a user may desire to perceive the historical navigation movement indication by way of a see through display, by way of augmented reality, and/or the like, similar as described regarding FIGS. 3A-3B. For example, a user may be wearing a see through display, and may desire to perceive the historical navigation movement indication by way of a see through display. In at least one example embodiment, the causation of display of the historical navigation movement indication comprises display of the historical navigation movement indication on a see through display such that the historical navigation movement indication corresponds with one or more object viewable through the see through display. For example, the apparatus may cause display of the historical navigation movement indication on a see through display such that the historical navigation movement indication corresponds a sign, a building, a road, a street, a walkway, a sidewalk, a path, a trail, a portion of ground, and/or the like. For example, a historical navigation movement indication may be associated with footprints, and the user may perceive the footprints to follow a path that indicates a historical navigation route. In another example, a historical navigation movement indication may be associated with an arrow, and the user may perceive the arrow to point in a direction associated with traversal of the historical navigation route.

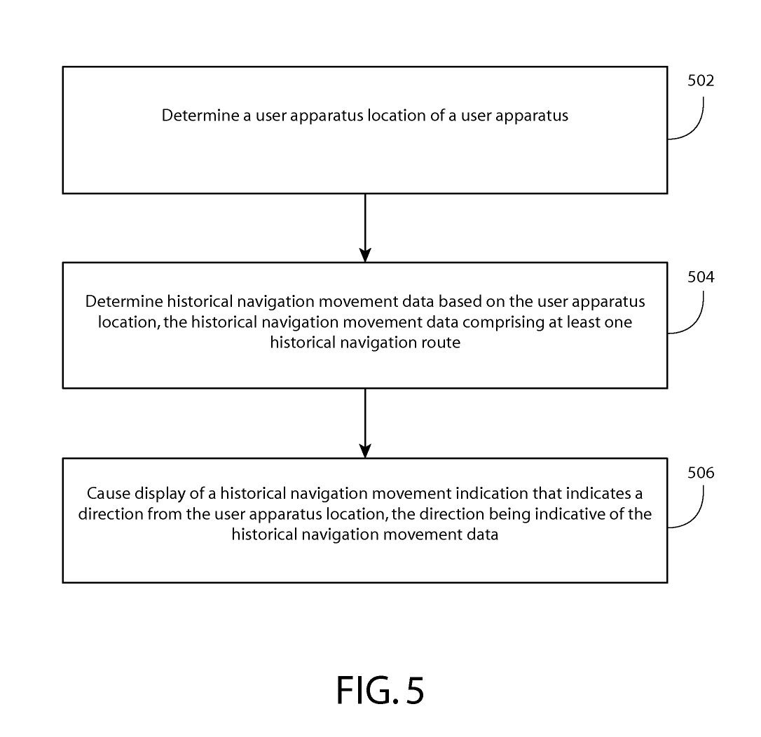

FIG. 5 is a flow diagram illustrating activities associated with causation of display of a historical navigation movement indication according to at least one example embodiment. In at least one example embodiment, there is a set of operations that corresponds with the activities of FIG. 5. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 5.

At block 502, the apparatus determines a user apparatus location of a user apparatus. The determination, the user apparatus, and the user apparatus location may be similar as described regarding FIGS. 3A-3B and FIGS. 4A-4F.

At block 504, the apparatus determines historical navigation movement data based, at least in part, on the user apparatus location. In at least one example embodiment, the historical navigation movement data comprises at least one historical navigation route. The determination, the historical navigation movement data, and the historical navigation route may be similar as described regarding FIGS. 3A-3B and FIGS. 4A-4F.

At block 506, the apparatus causes display of a historical navigation movement indication that indicates a direction from the user apparatus location. In at least one example embodiment, the direction is indicative of, at least a portion of, the historical navigation movement data. The causation of display, the historical navigation movement indication, and the direction may be similar as described regarding FIGS. 3A-3B and FIGS. 4A-4F.

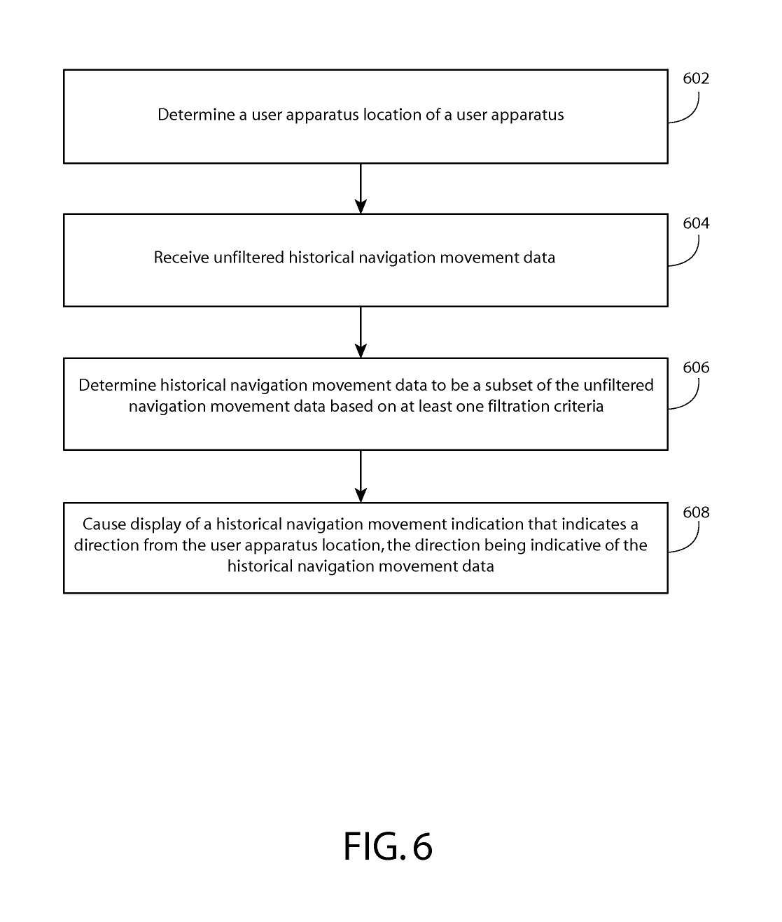

FIG. 6 is a flow diagram illustrating activities associated with causation of display of a historical navigation movement indication according to at least one example embodiment. In at least one example embodiment, there is a set of operations that corresponds with the activities of FIG. 6. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 6.

As discussed previously, in many circumstances, an apparatus may receive unfiltered historical navigation movement data. In such circumstances, the apparatus may determine historical navigation movement data to be a subset of the unfiltered historical navigation movement data based, at least in part, on one or more filtration criteria.

At block 602, the apparatus determines a user apparatus location of a user apparatus. The determination, the user apparatus, and the user apparatus location may be similar as described regarding FIGS. 3A-3B and FIGS. 4A-4F.

At block 604, the apparatus receives unfiltered historical navigation movement data. The receipt and the unfiltered historical navigation movement data may be similar as described regarding FIG. 2, FIGS. 3A-3B, and FIGS. 4A-4F.

At block 606, the apparatus determines the historical navigation movement data to be a subset of the unfiltered navigation movement data based, at least in part, on at least one filtration criteria. The determination and the subset of the unfiltered navigation movement data may be similar as described regarding FIGS. 3A-3B and FIGS. 4A-4F.

At block 608, the apparatus causes display of a historical navigation movement indication that indicates a direction from the user apparatus location. In at least one example embodiment, the direction is indicative of, at least a portion of, the historical navigation movement data. The causation of display, the historical navigation movement indication, and the direction may be similar as described regarding FIGS. 3A-3B and FIGS. 4A-4F.

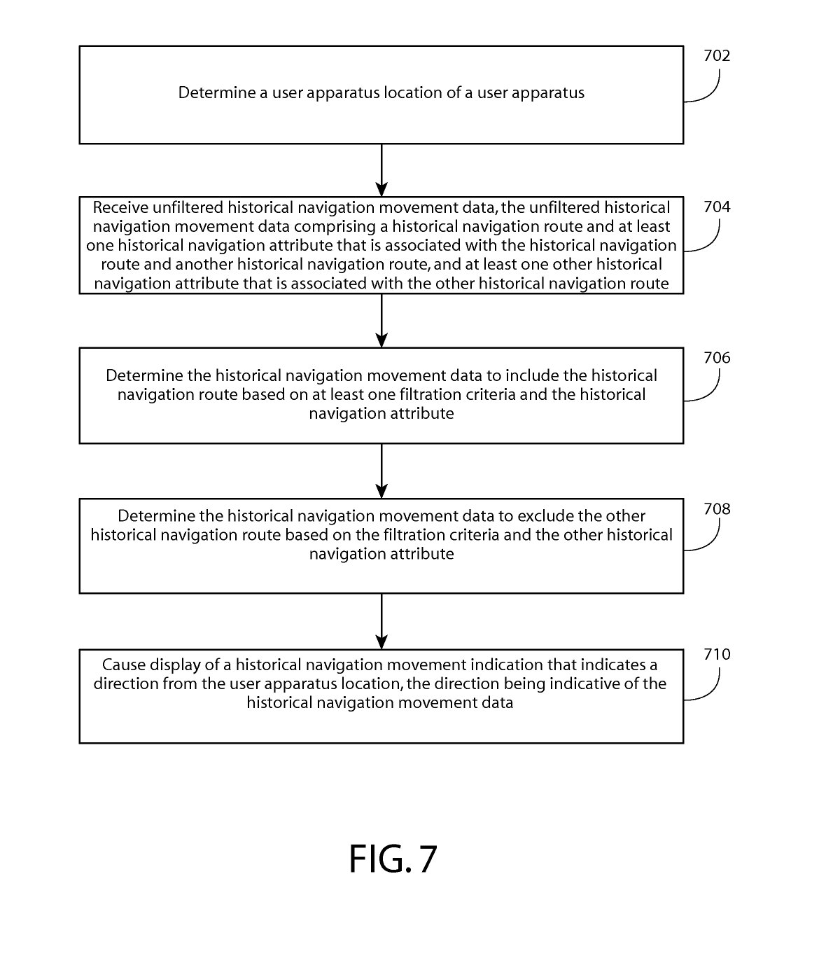

FIG. 7 is a flow diagram illustrating activities associated with causation of display of a historical navigation movement indication according to at least one example embodiment. In at least one example embodiment, there is a set of operations that corresponds with the activities of FIG. 7. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 7.

As discussed previously, in many circumstances, an apparatus may receive unfiltered historical navigation movement data. In such circumstances, the apparatus may determine historical navigation movement data to be a subset of the unfiltered historical navigation movement data based, at least in part, on one or more filtration criteria. For example, the apparatus may determine the historical navigation movement data to include a historical navigation route based, at least in part, on the filtration criteria and a historical navigation attribute associated with the historical navigation route. In another example, the apparatus may determine the historical navigation movement data to exclude another historical navigation route based, at least in part, on the filtration criteria and another historical navigation attribute associated with the other historical navigation route.

At block 702, the apparatus determines a user apparatus location of a user apparatus. The determination, the user apparatus, and the user apparatus location may be similar as described regarding FIGS. 3A-3B and FIGS. 4A-4F.

At block 704, the apparatus receives unfiltered historical navigation movement data. In at least one example embodiment, the unfiltered historical navigation movement data comprises a historical navigation route and at least one historical navigation attribute that is associated with the historical navigation route. In at least one example embodiment, the unfiltered historical navigation movement data comprises another historical navigation route and at least one other historical navigation attribute that is associated with the other historical navigation route. The receipt, the unfiltered historical navigation movement data, the historical navigation route, the historical navigation attribute that is associated with the historical navigation route, the other historical navigation route, the other historical navigation attribute that is associated with the other historical navigation route may be similar as described regarding FIG. 2, FIGS. 3A-3B, and FIGS. 4A-4F.

At block 706, the apparatus determines the historical navigation movement data to include the historical navigation route based, at least in part, on at least one filtration criteria and the historical navigation attribute. The determination, the inclusion of the historical navigation route, and the filtration criteria may be similar as described regarding FIGS. 3A-3B and FIGS. 4A-4F.

At block 708, the apparatus the historical navigation movement data to exclude the other historical navigation route based, at least in part, on the filtration criteria and the other historical navigation attribute. The determination and the exclusion of the other historical navigation route may be similar as described regarding FIGS. 3A-3B and FIGS. 4A-4F.

At block 710, the apparatus causes display of a historical navigation movement indication that indicates a direction from the user apparatus location. In at least one example embodiment, the direction is indicative of, at least a portion of, the historical navigation movement data. The causation of display, the historical navigation movement indication, and the direction may be similar as described regarding FIGS. 3A-3B and FIGS. 4A-4F.

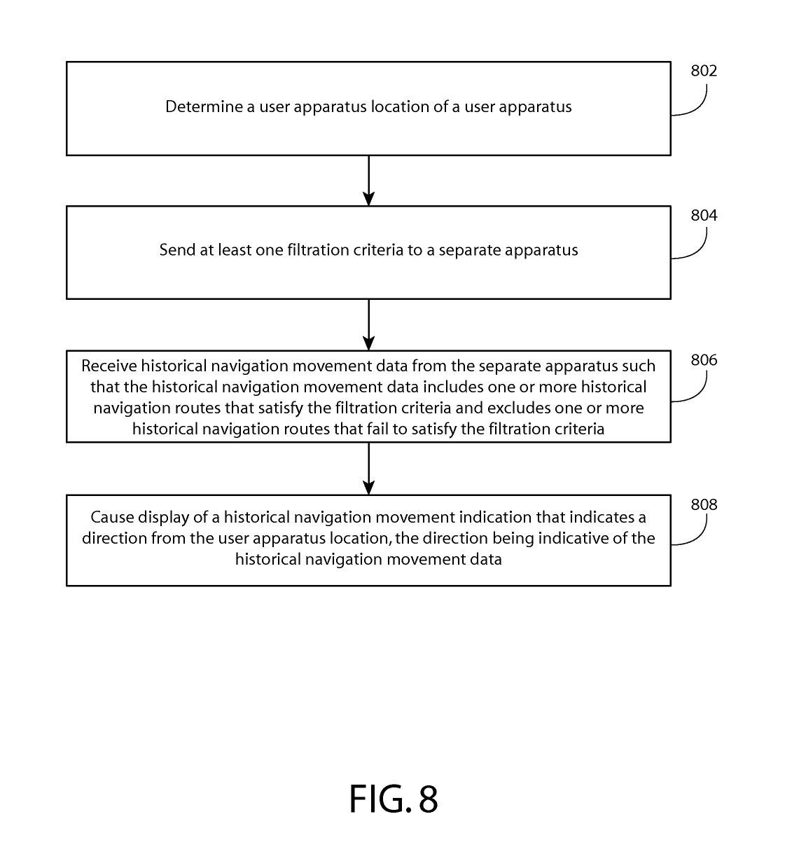

FIG. 8 is a flow diagram illustrating activities associated with causation of display of a historical navigation movement indication according to at least one example embodiment. In at least one example embodiment, there is a set of operations that corresponds with the activities of FIG. 8. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 8.

As discussed previously, in many circumstances, an apparatus may receive historical navigation movement data from a separate apparatus. In such circumstances, the apparatus may send information indicative of one or more filtration criteria to the separate apparatus, such that the apparatus receives the historical navigation movement data that includes one or more historical navigation routes that satisfy the filtration criteria.

At block 802, the apparatus determines a user apparatus location of a user apparatus. The determination, the user apparatus, and the user apparatus location may be similar as described regarding FIGS. 3A-3B and FIGS. 4A-4F.

At block 804, the apparatus sends at least one filtration criteria to a separate apparatus. The sending, the filtration criteria, and the separate apparatus may be similar as described regarding FIG. 2, FIGS. 3A-3B, and FIGS. 4A-4F.

At block 806, the apparatus receives historical navigation movement data from the separate apparatus such that the historical navigation movement data includes one or more historical navigations routes that satisfy the filtration criteria and excludes one or more historical navigation routes that fail to satisfy the filtration criteria. The receipt, the historical navigation movement data, the historical navigation routes that satisfy the filtration criteria, and the historical navigation routes that fail to satisfy the filtration criteria may be similar as described regarding FIG. 2, FIGS. 3A-3B, and FIGS. 4A-4F.

At block 808, the apparatus causes display of a historical navigation movement indication that indicates a direction from the user apparatus location. In at least one example embodiment, the direction is indicative of, at least a portion of, the historical navigation movement data. The causation of display, the historical navigation movement indication, and the direction may be similar as described regarding FIGS. 3A-3B and FIGS. 4A-4F.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media.

If desired, the different functions discussed herein may be performed in a different order and/or concurrently with each other. For example, block 802 of FIG. 8 may be performed after block 804 of FIG. 8. Furthermore, if desired, one or more of the above-described functions may be optional or may be combined. For example, block 708 of FIG. 7 may be optional and/or combined with block 706 of FIG. 7.

Although various aspects of embodiments are set out in the claims, the summary, and the description, other aspects of the embodiments comprise other combinations of features from other described embodiments. In this manner, the embodiments include the combinations explicitly set out in the claims, the summary, and the description, as well as any other suitable combinations of any suitable features.

It is also noted herein that while the above describes example embodiments, these descriptions should not be viewed in a limiting sense. Rather, there are variations and modifications which may be made without departing from the scope of the present disclosure.

What is claimed is:

1. An apparatus, comprising:
at least one processor;
at least one memory including computer program code, the memory and the computer program code configured to, working with the processor, cause the apparatus to perform at least the following:
determination of a user apparatus location of a user apparatus;
determination of historical navigation movement data based, at least in part, on the user apparatus location, the historical navigation movement data comprising at least one historical navigation route; and
causation of display of a historical navigation movement indication that indicates a direction from the user apparatus location, the direction being indicative of, at least a portion of, the historical navigation movement data.

2. The apparatus of claim 1, wherein the historical navigation route is associated with an apparatus that is different from the user apparatus.

3. The apparatus of claim 1, wherein the historical navigation movement data comprises at least one historical navigation attribute that is associated with the historical navigation route, the historical navigation attribute indicating at least one circumstance of a route traveled by an apparatus that is different from the user apparatus, the route being indicated by the historical navigation route.

4. The apparatus of claim 1, wherein the determination of the historical navigation movement data comprises receipt of unfiltered historical navigation movement data, and determination of the historical navigation movement data to be a subset of the unfiltered navigation movement data based, at least in part, on at least one filtration criteria.

5. The apparatus of claim 1, wherein the determination of the historical navigation movement data comprises receipt of unfiltered historical navigation movement data, the unfiltered historical navigation movement data comprising the historical navigation route and at least one historical navigation attribute that is associated with the historical navigation route and another historical navigation route and at least one other historical navigation attribute that is associated with the other historical navigation route, and determination of the historical navigation movement data to include the historical navigation route based, at least in part, on at least one filtration criteria and the historical navigation attribute.

6. The apparatus of claim 5, wherein the determination of the historical navigation movement data to include the historical navigation route comprises determination that the historical navigation attribute satisfies the filtration criteria, and the determination of the historical navigation movement data to include the historical navigation route is based, at least in part, on the determination that the historical navigation attribute satisfies the filtration criteria.

7. The apparatus of claim 5, wherein the determination of the historical navigation movement data comprises determination of the historical navigation movement data to exclude the other historical navigation route based, at least in part, on the filtration criteria and the other historical navigation attribute.

8. The apparatus of claim 1, wherein the determination of the historical navigation movement data comprises sending of at least one filtration criteria to a separate apparatus, and receipt of the historical navigation movement data from the separate apparatus such that the historical navigation movement data includes one or more historical navigation routes that satisfy the filtration criteria and excludes one or more historical navigation routes that fail to satisfy the filtration criteria.

9. The apparatus of claim 1, wherein the apparatus is the user apparatus, the user apparatus comprises a display, and the causation of display of the historical navigation movement indication comprises display of the historical navigation movement indication on the display.

10. A method comprising:
determining a user apparatus location of a user apparatus;
determining historical navigation movement data based, at least in part, on the user apparatus location, the historical navigation movement data comprising at least one historical navigation route; and
causing display of a historical navigation movement indication that indicates a direction from the user apparatus location, the direction being indicative of, at least a portion of, the historical navigation movement data.

11. The method of claim 10, wherein the historical navigation movement data comprises at least one historical navigation attribute that is associated with the historical navigation route, the historical navigation attribute indicating at least one circumstance of a route traveled by an apparatus that is different from the user apparatus, the route being indicated by the historical navigation route.

12. The method of claim 10, wherein the determination of the historical navigation movement data comprises receiving unfiltered historical navigation movement data, and determining the historical navigation movement data to be a subset of the unfiltered navigation movement data based, at least in part, on at least one filtration criteria.

13. The method of claim 10, wherein the determination of the historical navigation movement data comprises receiving unfiltered historical navigation movement data, the unfiltered historical navigation movement data comprising the historical navigation route and at least one historical navigation attribute that is associated with the historical navigation route and another historical navigation route and at least one other historical navigation attribute that is associated with the other historical navigation route, and determining the historical navigation movement data to include the historical navigation route based, at least in part, on at least one filtration criteria and the historical navigation attribute.

14. The method of claim 13, wherein the determination of the historical navigation movement data to include the historical navigation route comprises determining that the historical navigation attribute satisfies the filtration criteria, and the determination of the historical navigation movement data to include the historical navigation route is based, at least in part, on the determination that the historical navigation attribute satisfies the filtration criteria.

15. The method of claim 13, wherein the determination of the historical navigation movement data comprises determining the historical navigation movement data to exclude the other historical navigation route based, at least in part, on the filtration criteria and the other historical navigation attribute.

16. The method of claim 10, wherein the determination of the historical navigation movement data comprises sending at least one filtration criteria to a separate apparatus, and receiving the historical navigation movement data from the separate apparatus such that the historical navigation movement data includes one or more historical navigation routes that satisfy the filtration criteria and excludes one or more historical navigation routes that fail to satisfy the filtration criteria.

17. At least one computer-readable medium encoded with instructions that, when executed by a processor, perform:
determination of a user apparatus location of a user apparatus;
determination of historical navigation movement data based, at least in part, on the user apparatus location, the historical navigation movement data comprising at least one historical navigation route; and
causation of display of a historical navigation movement indication that indicates a direction from the user apparatus location, the direction being indicative of, at least a portion of, the historical navigation movement data.

18. The medium of claim 17, wherein the determination of the historical navigation movement data comprises receipt of unfiltered historical navigation movement data, and determination of the historical navigation movement data to be a subset of the unfiltered navigation movement data based, at least in part, on at least one filtration criteria.

19. The medium of claim 17, wherein the determination of the historical navigation movement data comprises receipt of unfiltered historical navigation movement data, the unfiltered historical navigation movement data comprising the historical navigation route and at least one historical navigation attribute that is associated with the historical navigation route and another historical navigation route and at least one other historical navigation attribute that is associated with the other historical navigation route, and determination of the historical navigation movement data to include the historical navigation route based, at least in part, on at least one filtration criteria and the historical navigation attribute.

20. The medium of claim 17, wherein the determination of the historical navigation movement data comprises sending of at least one filtration criteria to a separate apparatus, and receipt of the historical navigation movement data from the separate apparatus such that the historical navigation movement data includes one or more historical navigation routes that satisfy the filtration criteria and excludes one or more historical navigation routes that fail to satisfy the filtration criteria.
